(19) United States
(12) Patent Application Publication
(10) Pub. No.: US 2005/0128060 A1
(43) Pub. Date: Jun. 16, 2005

(54) Universally usable object detection system and method

(76) Inventors: Mark Rennick, (US); Patricia Rennick, Marietta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/993,821

(22) Filed: Nov. 19, 2004

Related U.S. Application Data
(60) Provisional application No. 60/523,459, filed on Nov. 19, 2003.

(51) Int. Cl. G05D 1/00

(52) U.S. Cl. 340/435; 340/693.9

(57) ABSTRACT

The universally useable object detection system disclosed herein comprises a plurality of positionable sensors coupled to the vehicle and positioned so as to direct energy into a predetermined area respective to the vehicle. The sensors may be temporarily or permanently attached to the vehicle. A control unit is electrically coupled to each sensor and detachably coupled to the vehicle. The control unit receives signals from the sensors corresponding to a detected presence of an object within a predetermined range of one or more sensors. The control unit is also electrically coupled to a power source of the vehicle. One or more visual alerting devices is electrically coupled to the control unit and detectably coupled to the vehicle so that a driver of the vehicle can see the alerting devices through one or more rear view mirrors of the vehicle.

### CROSS-REFERENCE TO RELATED APPLICATION

This application claims priority to copending U.S. provisional application entitled, “Universally Usable Reverse Detection System,” filed November 19, 2003 and having application Ser. No. 60/523,459, which is entirely incorporated herein by reference.

### TECHNICAL FIELD

The present disclosure generally relates to object detection systems and, more particularly, to a system and method for detecting objects and obstacles in the rear path of a vehicle.

### BACKGROUND

Each year, many accidents occur when a driver of a vehicle attempts to move the vehicle in reverse, subsequently resulting in a collision with another object. A driver's view when driving in reverse is typically not as good as when the vehicle is moving forward, thereby causing most drivers to rely on rear view mirrors and/or to constantly turn in an attempt to find obstacles within the path of the vehicle. However, due to the relative position of the driver in the vehicle, the driver's vantage point oftentimes results in the failure to see and/or maneuver around various stationary or moving obstacles. It is not uncommon for drivers of rear moving vehicles to strike other people who may walk or otherwise move into the path of the rear-moving vehicle, unbeknownst to the driver. In these situations, when the obstacle is a person, such as a child who may dart into the path of the rear-moving vehicle, the consequences can be catastrophic.

Even when relying on rear view mirrors and moving in reverse, a driver still may not be able to see a stationary or moving object that may be in the driver's blind spot. Thus, late model vehicles are increasingly being equipped by manufacturers with object detection systems that aid the driver handle the vehicle so as to avoid obstacles in the path of the rear-moving vehicle.

Although such systems vary, at least one such solution includes the placement of a camera in the rear portion of the vehicle so as to capture images of the area behind the vehicle, which is simultaneously displayed on the screen viewable by the driver. In this way, a driver at least has a viewable image of the area behind the rear-moving vehicle so as to see obstacles that may be in the path.

However, even cameras are constrained by the respective fields of view, which means that a camera may also have a blind spot or experience poor resolution depending on ambient lighting conditions. Furthermore, weather conditions and other environmental conditions may result in a poor image quality viewed by the driver, thereby negating any substantial beneficial effect that a camera system may provide.

Manufacturers also have begun equipping new vehicles with automatic sensing systems to detect objects by including in the newly manufactured vehicle one or more rear facing sensors that may detect the presence of objects within a predetermined range. When an obstacle comes within the vehicle's path, an emitted signal wave may be disturbed or reflected back to the sensor, thereby indicating to the driver by processing electronics that an obstacle is in the path of the rear moving vehicle. Thus, it is possible according to this solution to increase the awareness of the driver as to obstacles that may be in the rear path so as to prevent damage to the vehicle and/or injury to passengers in the vehicle or to persons that may be within the path of the vehicle.

While such systems may be employed in newly manufactured vehicles to effectively reduce the number of collisions by such vehicles when moving in reverse, this solution does not account for the millions of existing vehicles that are in use and were manufactured prior to the development of such safety systems, as well as particular vehicle configuration types that may not necessarily lend themselves to these manufacturer-installed detection systems.

The use of object detection systems to aid a driver when moving in reverse is found mostly in passenger vehicles and conventional light trucks. The application of these safety systems to larger trucks and especially to tractor-trailer rigs and specialty vehicles, such as sanitation trucks and dump trucks, is found much less frequently. For example, many current object detection systems utilize a hardwiring harnesses to electrically connect the sensors in the rear of the vehicle to an electrical control unit that may be in the front portion of the vehicle to audio or visual alerting means that may also be in the front of the vehicle. Depending on the vehicle type, extending a wiring harness throughout the length of a vehicle may be prohibited due to vehicle construction.

As a nonlimiting example, a rear loading sanitation truck that has various moving parts at the rear portion of the vehicle may not be ideally suited for the installation of certain obstacle detection systems after initial manufacture. Because of the moving parts on this vehicle associated with trash collection, placing the various components and routing the associated wiring harnesses may be impractical, especially if the control unit is positioned away from the sensors and alerting devices.

There have been attempts to overcome these limitations; however, the solutions have been limited. For example, transmitting data from sensors to a control unit near the front of the vehicle via wireless means, such as radio or microwave, is one such solution. However, this scheme often is not practical for trucks with detachable trailers due to the fact that a driver of a vehicle may tow a multitude of trailers in relatively short periods of time. Thus, such wireless transmitters are typically either universal or configured in such a way wherein the driver may easily determine and tune to the appropriate frequency so as to receive and understand communications from a transmitter in the rear portion of the vehicle.

If such devices are configured to include a wide range of frequencies, efforts need to be made to prevent unintentional interception by a receiver of another vehicle. More specifically, and as a nonlimiting example, if one vehicle is moving in reverse at, for example, a truck stop and detects an obstacle, the wireless communication reporting the detected obstacle may very well be received by a nearby vehicle also moving in reverse, which would thereafter be reported to the driver as an obstacle within the rear path of his vehicle, even though the obstacle is in the rear path of another vehicle.

The complexity and function of hardwired or radio frequency systems may ultimately render these systems impractical for use in certain situations and applications. Sanitation trucks, as a nonlimiting example, have an articulated chassis and carry electromechanical equipment that may interfere with a transmitted RF signal. So as to overcome interference with other electrical components in an effort to increase the efficiency of the wireless communications, the cost of such components may be greater.

Thus, there is a heretofore unaddressed need to resolve the deficiencies and problems described above.

### BRIEF DESCRIPTION OF THE DRAWINGS

Many aspects of the invention can be better understood with reference to the following drawings. The components in the drawings are not necessarily to scale, emphasis instead being placed upon clearly illustrating the principals of the present invention. Moreover, in the drawings, like reference numerals designate corresponding parts throughout the several views.

FIG. 1 is a diagram of a tractor trailer rig comprised of a tractor and a trailer.

FIG. 2 is a diagram of an exemplary embodiment of the tractor trailer rig of FIG. 1 equipped with rear detection sensors on the rear portion of the trailer to detect objects behind the tractor trailer rig.

FIG. 3 is a diagram of an exemplary embodiment of the tractor trailer rig of FIGS. 1 and 2 with sensors configured to detect the presence of an obstacle and to report the detection of that presence to the driver in the tractor.

FIG. 4A is a side view diagram of an exemplary embodiment of the tractor trailer rig of FIG. 3 approaching an obstacle.

FIG. 4B is a diagram of an exemplary embodiment of a rear portion of the trailer of FIG. 4A to show at least a nonlimiting example of the object detection system disclosed herein and as shown in FIG. 3.

FIG. 5 is a diagram of an exemplary embodiment of a rear portion of the trailer of the tractor trailer rig of FIG. 1.

FIG. 6 is a perspective view diagram of an exemplary embodiment of the tractor trailer rig of FIG. 3.

FIG. 7 is a nonlimiting example diagram of a sanitation truck equipped with an object detection system of FIGS. 2-4A.

FIG. 8 is a diagram of an exemplary embodiment of the flatbed tractor trailer rig equipped with an object detection system, as shown in FIG. 4A.

FIG. 9 is a diagram of an exemplary embodiment of a box truck that is also configured with an object detection system of FIG. 4A.

FIG. 10 is a diagram of an exemplary embodiment of the tractor trailer rig of FIG. 1 equipped with an object detection system having a wireless transmission system.

FIG. 11 is a side view diagram of an exemplary embodiment of the tractor trailer rig of FIG. 10 depicting the alerting mechanism of alert and receiver upon the detection of an object in the rear driving path of the tractor trailer rig.

FIG. 12 is a diagram of an exemplary embodiment of the electrical control unit of FIG. 4A

FIG. 13 is a diagram depicting an exemplary embodiment of the visual indicator coupled to the side of the trailer of FIG. 4A.

### DETAILED DESCRIPTION

In addition to the drawings discussed above, this description describes one or more embodiments as illustrated in the above-referenced drawings.

However, there is no intent to limit this disclosure to a single embodiment or embodiments that are disclosed herein. On the contrary, the intent is to cover all alternatives, modifications, and equivalents included within the spirit and scope of this disclosure and as defined by the appended claims.

A universally useable object detection system is disclosed herein, which may be temporarily or permanently positioned on an existing vehicle not previously equipped with such a system during manufacture. As a nonlimiting example, a driver of any tractor trailer rig for pulling commercial trailers may be able to simply connect to any trailer so equipped with a universally useable object detection system and be able to use it without any additional equipment in the cab of the tractor trailer rig so as to be able to move in reverse and to detect obstacles within the rear path of the vehicle.

In one embodiment among others, a universally useable object detection system comprises a plurality of positionable sensors, such as ultrasonic sensors, positioned on a vehicle in a direction so as to direct energy into a predetermined area respective to the vehicle, such as, for example, in the rear driving path of the vehicle. A control unit is electrically coupled to each sensor and is also detachably coupled to the vehicle proximate to the sensors. As a nonlimiting example, the control unit may be located under the vehicle near the rear of the vehicle. The control unit may be configured to receive signals from the sensors corresponding to a detected presence of an object within a predetermined range of one or more of the sensors. One or more audio and/or visual alerting devices are electrically coupled to the control unit and detachably coupled to the vehicle so that a driver of the vehicle can see the one or more alerting devices through one or more rear view mirrors of the vehicle.

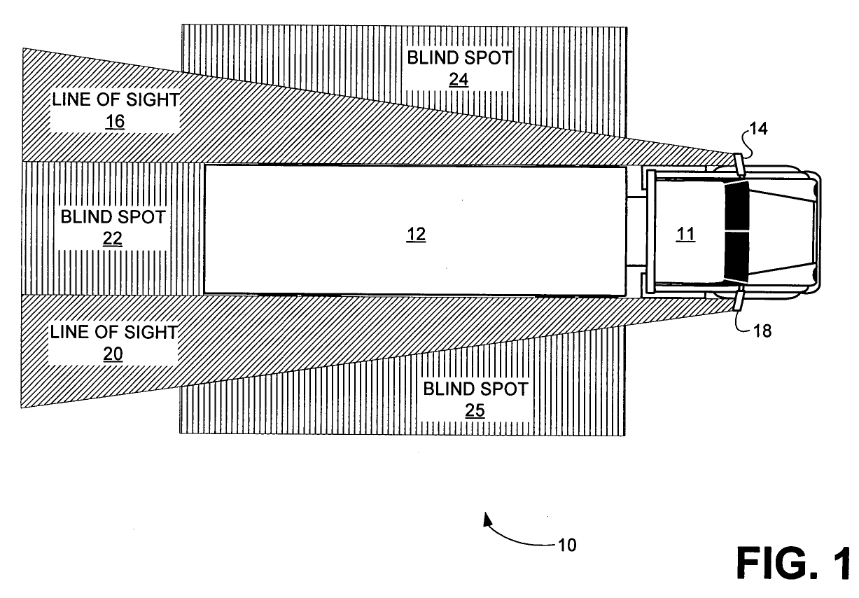

FIG. 1 is a diagram of tractor trailer rig 10 comprised of tractor 11 and trailer 12. When tractor trailer rig 10 moves in reverse, the driver may utilize mirror 14 to view obstacles that may be in the line of sight area 16 on the left side of the vehicle. Similarly, the driver may utilize rear view mirror 18 to view into the line of sight area 20 for detecting obstacles and objects in this region to the right side of the vehicle. Thus, as the driver moves in reverse, objects that reside in line of sight areas 16, 20 may be viewable to the driver through rear view mirrors 14, 18 so that the driver may take evasive maneuvers to avoid collisions.

However, the driver of tractor 11 has at least three blind spots that include blind spot 22 directly behind trailer 12, as well as blind spots 24, 25 which are beyond the line of sight areas 16, 20 described above. Thus, for an obstacle residing in any of these blind spots 22, 24, 25, the driver of tractor 11 may not see these obstacles, thereby resulting in a collision when moving in reverse.

Further, due to the long distances from the driver as positioned in tractor 11 and the rear of the trailer to a loading dock or other obstacle, the ability of the driver to precisely judge the distance from the rear of the trailer to the obstacle even with use of the rear view mirrors may be greatly impeded. With rigs not equipped with the object detection systems described above, a driver may typically maneuver the vehicle by rear view mirrors 14, 18 so as to place the dock or other intended final destination within the line of sight areas 16, 20. However, due to the inexperience of the driver and/or other conditions, such as a moving obstacle that may come into the path of the rear moving tractor trailer rig 10, the driver may not always be aware of whether the path behind the tractor is clear for attempting maneuvers.

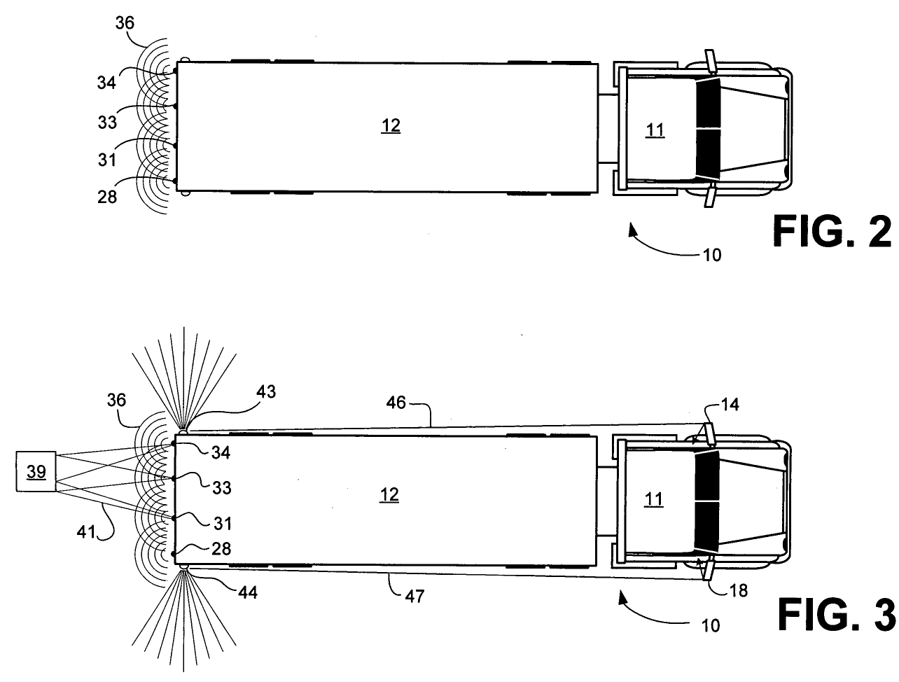

FIG. 2 is a diagram of an exemplary embodiment of tractor trailer rig 10 equipped with rear detection sensors 28, 31, 33, and 34 on the rear portion of trailer 12 to detect objects behind the tractor trailer rig 10. In this nonlimiting example, sensors 28, 31, 33, and 34 may be any type of ultrasonic, microwave, infrared, or scanning laser type detectors that may be fastened or otherwise attached to a rear area of trailer 12. More specifically, one of ordinary skill would know of various sensor technologies that could operate as sensors 28, 31, 33, and 34 and also that a greater or lesser number of sensors may be implemented in an application.

If sensors 28, 31, 33, and 34, as a nonlimiting example, are ultrasonic sensors, ultrasonic energy 36 is emitted in the rear driving path of tractor trailer rig 10 into a predetermined area for detecting objects. Furthermore, sensors 28, 31, 33, and 34 may be fastened to tractor trailer rig 10 by any known means such as screws, bolts, straps, magnets, clips, as well as any other means known to one of ordinary skill in the art. In this way, these sensors 28, 31, 33, and 34 may be fastened to trailer 12 that was not otherwise equipped with such sensors during its manufacture.

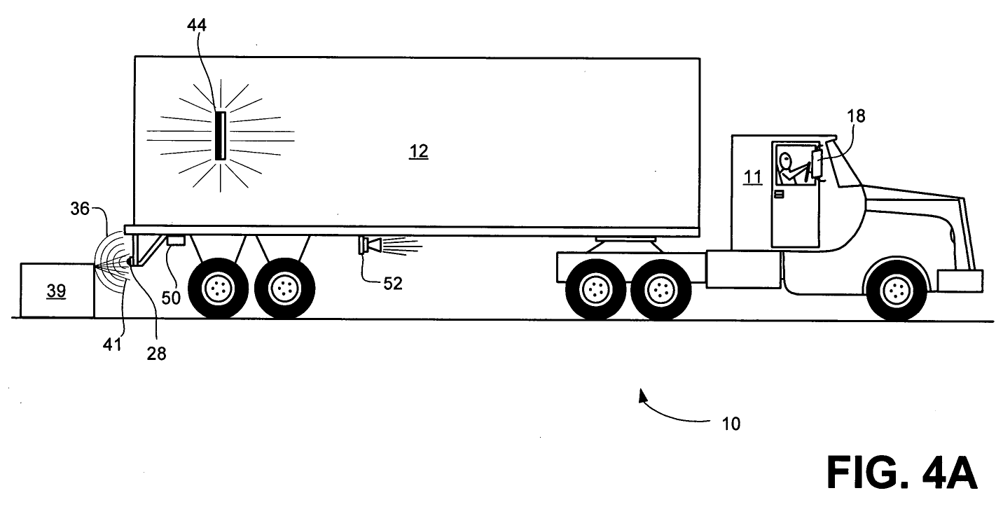

FIG. 3 is a diagram of an exemplary embodiment of the tractor trailer rig 10 of FIGS. 1 and 2 with sensors 28, 31, 33, and 34 configured to detect the presence of an obstacle and to report the detection of that presence to the driver in tractor 11. In this nonlimiting example, obstacle 39 may be detected by the ultrasonic energy 36 which is reflected back to the sensors, as shown by reference numeral 41. An electrical control unit, which is not shown in FIG. 3 but is shown in subsequent figures, receives a signal from sensors 28, 31, 33, and/or 34 corresponding to the detection of object 39. The electrical control unit thereafter activates visual alerting indicators 43, 44 positioned on either side of trailer 12, as shown in FIG. 3. The visual alerting indicators 43, 44 may be configured to go from a state of “off” to “on” or perhaps to otherwise go from one type of light to a different type of light so as to indicate to the driver the detection of obstacle 39. As a more specific nonlimiting example, indicators 43 and 44 may be configured to change colors from, as a nonlimiting example, green to red upon the detection of obstacle 39 or may be simply configured to go from an “off” status to an illuminated status such that light beams 46 and 44 are reflected from rear view mirrors 14 and 18 respectively to the driver in tractor 11. Upon detection of these light beams, the driver may, through the driver's rear view mirror, interpret this alert to mean that an obstacle is within the rear driving path of the vehicle, thereby leading the driver to take evasive maneuvers to avoid collision with the object.

One of ordinary skill would also know that the visual alerting indicators 43, 44 may be configured to flash or otherwise communicate distance information via changing the lighting pattern or brightness as trailer 12 approaches object 39. Stated another way, as tractor trailer rig 10 moves closer to object 39, the electrical control unit may receive a varied signal from the sensors 28, 31, 33, and 34 indicating the closing proximity of object 39. Thus, the electrical control unit may cause the visual alerting indicators 43, 44 to flash in a more rapid sequence or to change color to yet a third or a different color configuration to indicate the closing proximity. One of ordinary skill would know that indicators 43, 44 could be configured in a variety of illumination formats so as to communicate the detection of an object to the driver and/or range to the object.

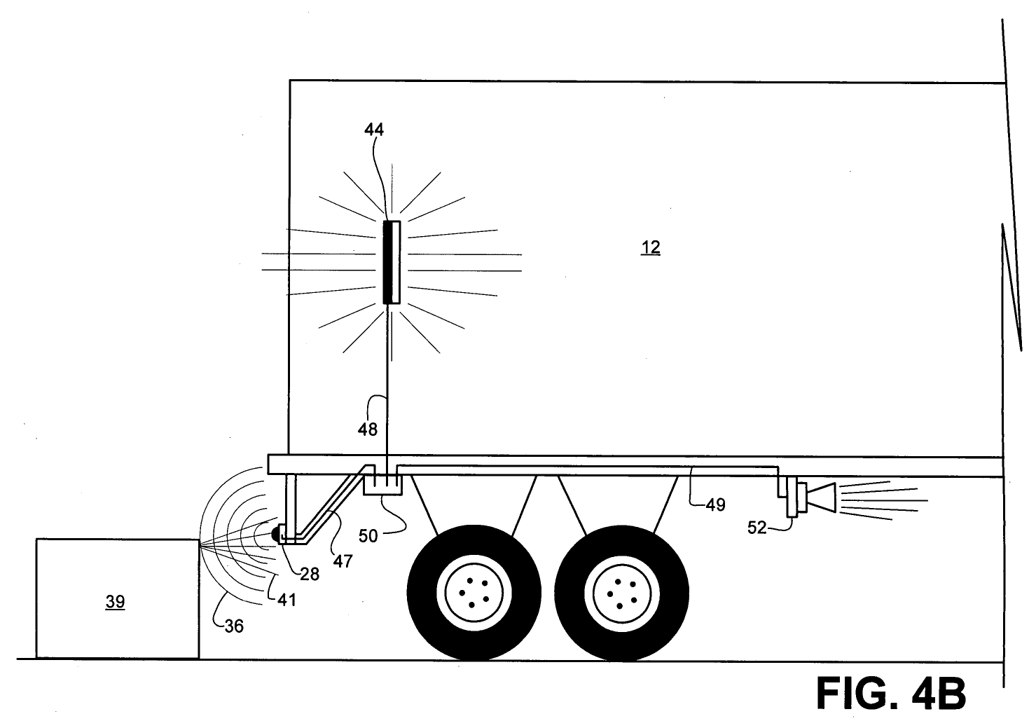

FIGS. 4A and 4B are side view diagrams of an exemplary embodiment of the tractor trailer rig 10 approaching obstacle 39, as shown in FIG. 3. In the side view diagram, tractor trailer rig 10, while moving in reverse toward object 39, is in pending danger of colliding with object 39, thereby causing damage to either trailer 12 and/or object 39.

However, the object detection system as described herein may include sensor 28 that emits ultrasonic energy 36, as a nonlimiting example, which strikes object 39 and is reflected back as reflected energy 41. Reflected energy 41 is detected by sensor 28. This detected reflection is communicated to electrical control unit 50, which recognizes the signal as indicating the detected presence of an object within the rear driving path of tractor trailer rig 10. Electrical control unit 50 may thereafter activate visual alerting indicator 44 (and also indicator 43 in FIG. 3) as well as audio alerting indicator 52 in order to notify the driver in tractor 11. Thus, the driver in tractor 11, when looking through rear view mirror 18, may see the illumination of visual alerting indicator 44 communicating the presence of object 39 within the rear driving path of the tractor trailer rig 10.

FIG. 4B is a diagram of an exemplary embodiment of the rear portion of trailer 10 and object 39 to describe at least a nonlimiting example of the object detection system disclosed herein and as shown in FIG. 3. In this nonlimiting example, the electrical control unit 50 is placed in the rear portion of trailer 12 proximate to sensor 28 (and the other sensors not shown in this figure) so that the communication path via a wiring harness 47 may be relatively short. Likewise, electrical control unit 50 is also coupled to visual alerting indicator 44 by wiring harness 48, which in this nonlimiting example is a relatively short span. Finally, electrical control unit 50 is coupled to audio alerting indicator 52 by wiring harness 49 in similar fashion.

As a further nonlimiting example, the electrical control unit 50 may be attached to the underportion of trailer 12 by screws, bolts, or other attaching means, as one of ordinary skill in the art would know, and also electrically coupled with the existing power system of the trailer. More specifically, a trailer may be electrically connected to the battery or other power source within the tractor 11 of FIG. 4A; however, the electrical control unit may be electrically coupled with the existing wiring harness to lights, for example, so as to draw power from the power source within tractor 11 for activating and operating the object detection system described herein. For this reason, electrical control unit 50, sensor 28 (as well as the other sensors described above), visual indicator 44, and audio indicator 52 may either temporarily or permanently remain on trailer 12 irrespective of any additional configuration in tractor 11. As further described above, any tractor 11 may be coupled to trailer 12 as shown in FIG. 4A and be able to detect objects within the rear driving path of the vehicle without additional equipment and additional specialized equipment within the tractor 11 because the entire object detection system, including sensors, the control unit, and visual and audio indicators, is contained on trailer 12.

As to the operation of the object detection system in FIG. 4B, the emitted ultrasonic energy 36 impacts object 39 and is reflected as signal waves 41 back to sensor 28. Sensor 28 communicates this detected presence to the electrical control unit 50 on the underside of trailer 12 via harness 47, which, thereafter, activates visual indicator 44 and audio indicator 52 by wiring harnesses 48 and 49, respectively.

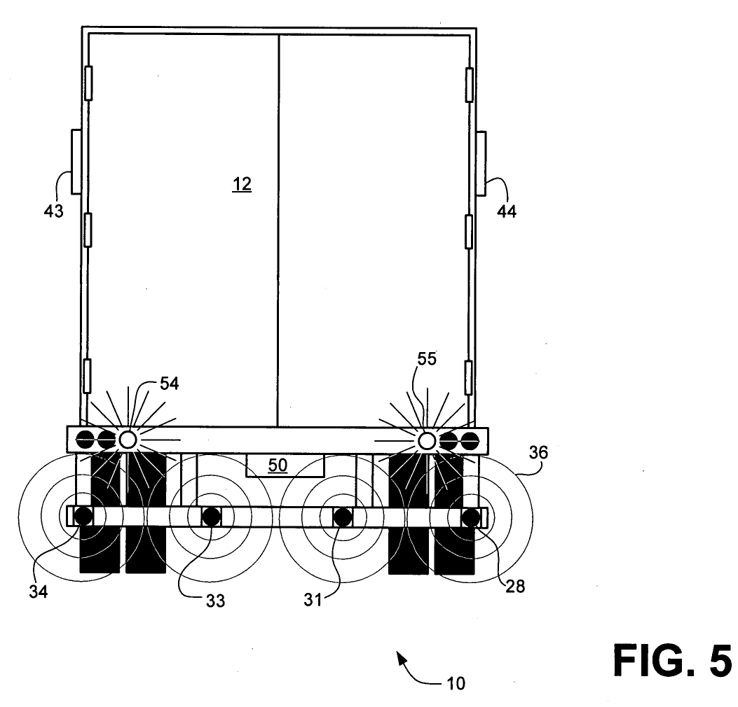

FIG. 5 is a diagram of an exemplary embodiment of a rear portion of trailer 12 of the tractor trailer rig 10 of FIG. 1. In this nonlimiting example, the tractor trailer rig 10 is prepared to move in reverse, as indicated by reverse indicator lights 54 and 55. As these lights 54, 55 are illuminated, the electrical control unit 50 is thereby activated, causing sensors 28, 31, 33, and 34 to activate as well. As a result, ultrasonic energy 36 is emitted from each of sensors 28, 31, 33 and 34 into the area behind the rear of trailer 12. Although not shown illuminated, visual indicators 43 and 44 are positioned along either side of trailer 12 such that, when illuminated, the driver in tractor 11 may detect the illumination of indicators 43 and 44 in this position.

One of ordinary skill in the art would know that various types of cabling and/or wiring harnesses may be implemented for connecting control unit 50 with each of sensors 28, 31, 33, and 34, as well as visual indicators 43 and 44. As one nonlimiting example, cabling with detachable connectors may be utilized for temporary or extended use applications of the object detection system on trailer 12 in FIG. 5.

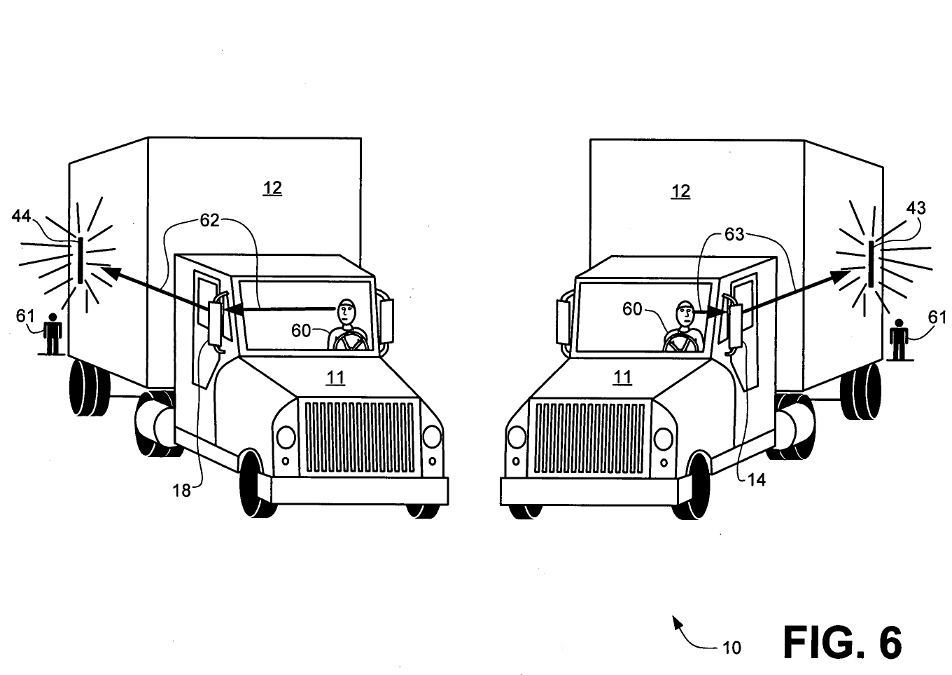

FIG. 6 is a perspective view diagram of an exemplary embodiment of the tractor trailer rig 10 of FIG. 3. More specifically, FIG. 6 depicts two perspective view diagrams of tractor trailer rig 10 to show the illumination of the visual indicators 43 and 44 respective to the driver 60 of the tractor trailer rig 10. On the left side portion of FIG. 6, driver 60 may view the illumination of visual indicator 44 via rear view mirror 18. Thus, sight line 62, as reflected through mirror 18, enables the driver to see the illumination of visual indicator 44 on the side of trailer 12. So a person 61 positioned within the rear driving path of tractor trailer rig 10 may be detected by the sensors described and shown in FIG. 5 so as to cause the visual indicator 44 to illuminate, thereby notifying the driver of the presence of an obstacle behind the tractor trailer rig 10.

Likewise, the right side portion of FIG. 6 shows the driver's 60 viewing of the illumination of visual indicator 43 through right side rear view mirror 14. Sight path 63 enables the driver to look through rear view mirror 14 to see the illumination of visual indicator 43 when person 61 is positioned within the rear driving path of tractor trailer rig 10.

Thus far, the object detection system of this disclosure has been described as implemented on a tractor trailer rig 10. However, one of ordinary skill in the art would know that this system may be implemented on various types of vehicles, either permanently or temporarily, irrespective of any special electronics within the driving cab of the vehicle for which the system is installed.

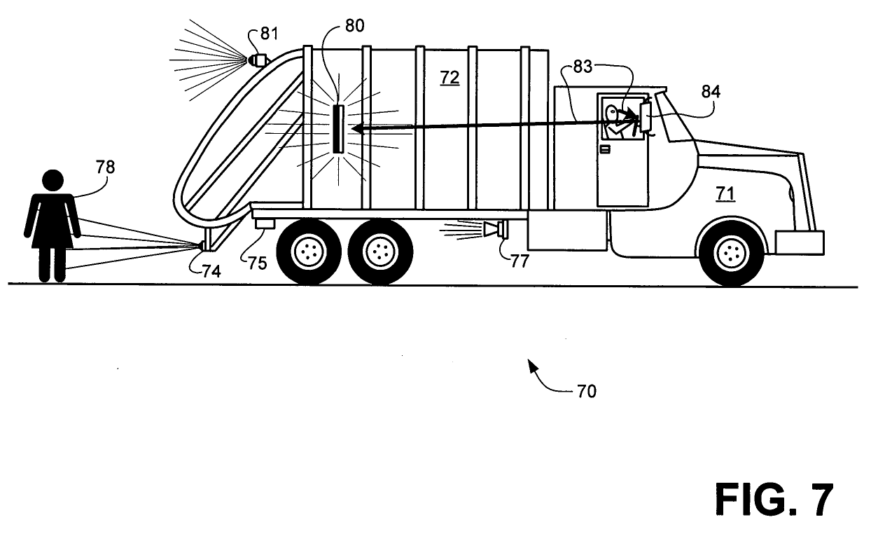

FIG. 7 is a nonlimiting example diagram of a sanitation truck 70 equipped with an object detection system described above. In this nonlimiting example, sanitation truck 10 includes one or more sensors 74 positioned so as to emit ultrasonic energy, in this nonlimiting example, into a rear driving path of the sanitation truck 70. As discussed above, sensors 74 are electrically coupled to electrical control unit 75, which is configured to receive signals corresponding to the detected presence of an obstacle, such as person 78, within the rear driving path of sanitation truck 70. In such instances, electrical control unit 75 causes audio indicator 77 to produce an alerting sound that may be recognizable by the driver of the sanitation truck 70 in cab 71 as well as by the person 78 within the rear driving path of the sanitation truck. As described above, the driver in cab 71 via sight path 83 and rear view mirror 84 may see the illumination of visual indicator 80 placed upon the side of the rear portion 72 of sanitation truck 70.

One or more additional visual indicators 81 may be positioned at the rear of sanitation truck 70 so as to give person 78 within the rear driving path of the vehicle an additional warning of the approaching sanitation truck 70. The inclusion of visual indicator 81 and audio indicator 77 on sanitation truck 70 is merely a nonlimiting example, as one of ordinary skill in the art would know that one or both of these alerting devices as well as other types of alerts may be activated by the electrical control unit 75 upon the detection of person 78 (or other object) within the rear driving path of sanitation truck 70. As an additional nonlimiting example, electrical control unit 75 may be configured to produce an output signal that causes the sanitation truck 70 to automatically actuate its brakes or otherwise terminate its engine so as to cease the rear movement toward person 78.

It should be noted that the object detection system shown in FIG. 7 may be installed on sanitation truck 70 in a manner so as to avoid any moving portions of the truck. By locating electrical control unit 75 near the sensors 74, installation of the system is simpler due in part to the avoidance of extended wiring runs. Installation in this manner enables use of the system, irrespective of the vehicle's moving components.

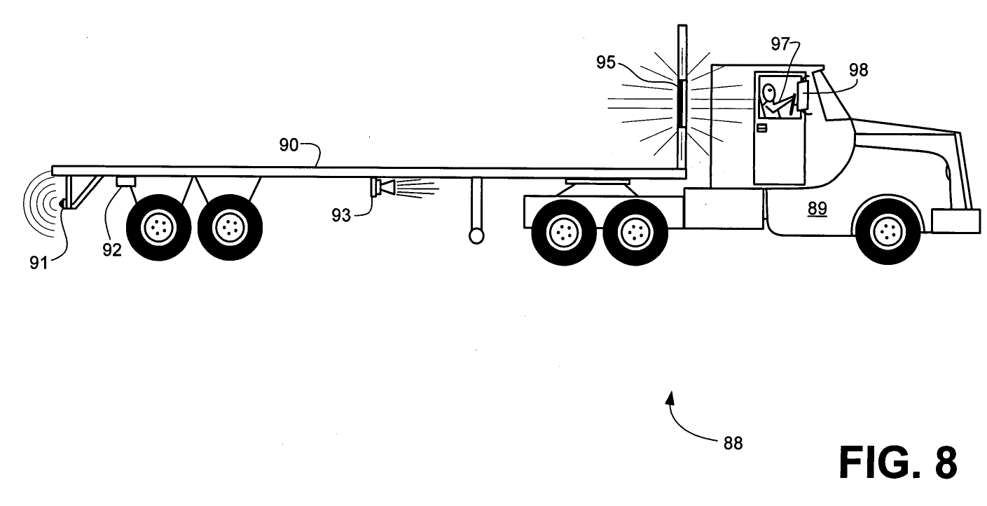

FIG. 8 is a diagram of an exemplary embodiment of a flatbed tractor trailer rig 88 comprising a tractor 89 and flatbed trailer 90. In this nonlimiting example, one or more sensors 91 may be positioned at a rear portion of the vehicle by one or more of the means described above and electrically coupled to electrical control unit 92 in the same manner as described above, which is positioned near the rear of flatbed trailer 90. Upon the detection of an obstacle within the rear driving path of flatbed tractor trailer rig 88, electrical control unit 92 may activate audio indicator 93 and/or visual indicator 95, which in this nonlimiting example is positioned near the front portion of flatbed trailer 90 proximate to the tractor 89. Just like above, visual indicator 95 may be on either side of flatbed trailer 90 so that the driver may view the illumination of visual indicator 95 through rear view mirror 98 on the right side of the vehicle and through the similar rear view mirror on the left side of the vehicle (not shown). Thus, driver 97 may use rear view mirror 98 to view the illumination of visual indicator 95 upon the detection of an object within the rear driving path of flatbed tractor trailer rig 88.

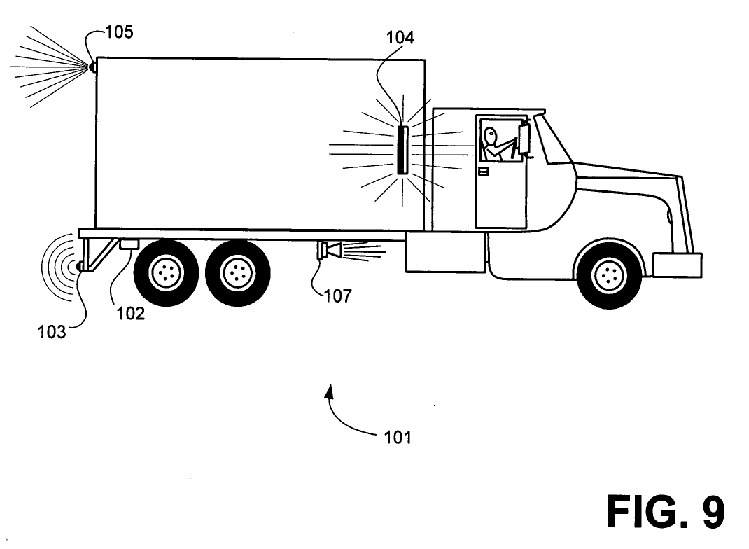

FIG. 9 is a diagram of an exemplary embodiment of box truck 101 that is also configured with an object detection system including one or more sensors 103 coupled to the electrical control unit 102. In this nonlimiting example, box truck 101 may be equipped with the object detection system described in this disclosure subsequent to its manufacture by attaching electrical control unit 102, sensors 103, visual indicators 104 and 105, and audio indicators 107 to the box truck 101. Similarly, electrical wiring harnesses may be routed between the various components described above, as one of ordinary skill in the art would know. Thus, the driver of box truck 101 may utilize rear view mirror 109 to view the illumination of visual indicator 104 as well as hear the report of audio indicator 107. As similarly discussed above, visual indicator 105 may be positioned in the rear portion of box truck 101 so as to alert a person who may be within the rear driving path of the vehicle so as to take evasive action as the box truck 101 approaches.

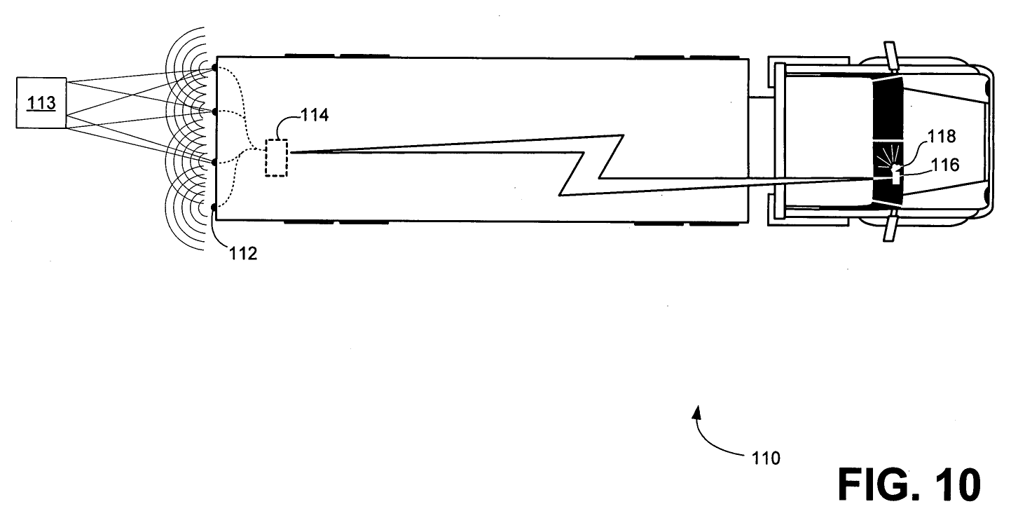

Although some of the problems of wireless communications in object detection systems are described above, the electrical control unit may indeed be programmed with a transmitter so as to securely, reliably, and wirelessly communicate the detection of objects within the rear driving path of a vehicle to an alerting device that may be positioned on another part of the vehicle. More specifically, FIG. 10 is a diagram of an exemplary embodiment of tractor trailer 110 equipped for wireless alerts. In this nonlimiting example, tractor trailer 110 includes one or more sensors 112 positioned so as to emit ultrasonic energy, as a nonlimiting example, into the rear driving path of the tractor trailer 110. The sensors 112 are electrically coupled to electronic control unit 114, which is shown in dashed lines as it may be positioned on an under portion of tractor trailer 110, as described above. Thus, upon the detection of object 113 within the rear driving path of tractor trailer 110, sensors 112 communicate the detected presence to electrical control unit 114.

In this nonlimiting example, electrical control unit 114 may be equipped with a wireless communication device such as an RF transmitter or other similar device so as to communicate an alerting message to a wireless receiver 116 that may be positioned within the cab of the tractor trailer 110. Although shown as separate components, one of ordinary skill in the art would know that visual and/or audio alerting device 118 may be an integral portion with receiver 116 or a separate component that is electrically coupled to the receiver 116. In this nonlimiting example, receiver 116 receives a wireless communication from the transmitter of electrical control unit 114, and alerting indicator 118 thereafter produces an alerting message, which is either visual, audio, or both, to the driver of tractor trailer rig 110.

One of ordinary skill in the art would know, however, that other nonlimiting examples may be implemented in addition to the receiver 116 and indicator 118. As a nonlimiting example, the transmitter in electrical control unit 114 may transmit an AM or FM signal receivable by an in-dash radio in the cab of the tractor trailer rig 110, which the driver may tune to when attempting reverse driving. Thus, when object 113 is detected, a signal is broadcast from electrical control unit 114 that is received and output by the radio system in the cab of tractor trailer rig 110, thereby informing the driver of the presence of the detected object.

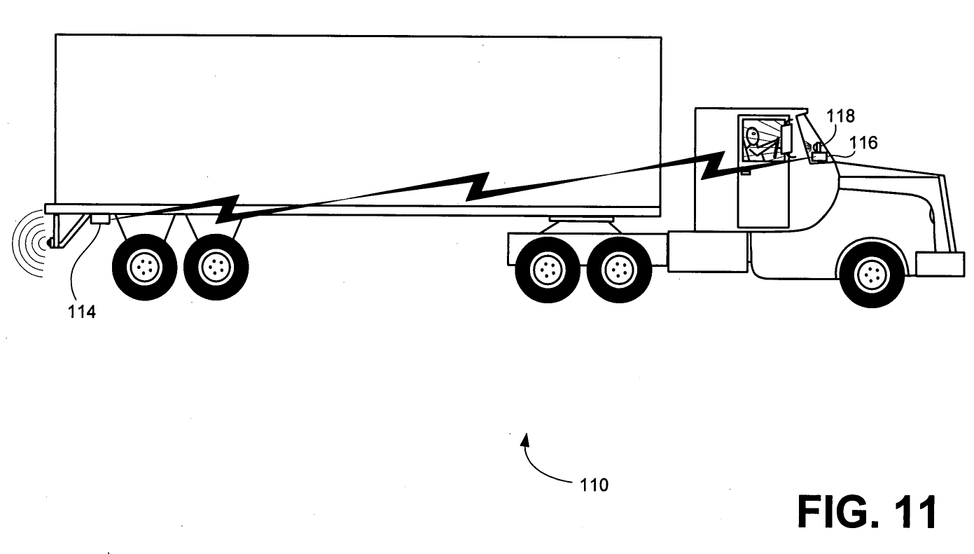

FIG. 11 is a side view diagram of an exemplary embodiment of the tractor trailer rig 110 depicting the alerting mechanism of alert 118 and receiver 116 upon the detection of an object in the rear driving path of tractor trailer rig 110. As discussed in FIG. 10, electrical control unit 114 in this nonlimiting example is positioned on the underside of the tractor trailer 110 and is equipped with a wireless transmitter to communicate the detection of an object within the rear driving path of the tractor trailer rig 110 to the driver in the cab. The output of alert indicator 118 may be audio, visual, or both as described above, so as to communicate to the driver the detection of an object within the rear driving path of tractor trailer rig 110.

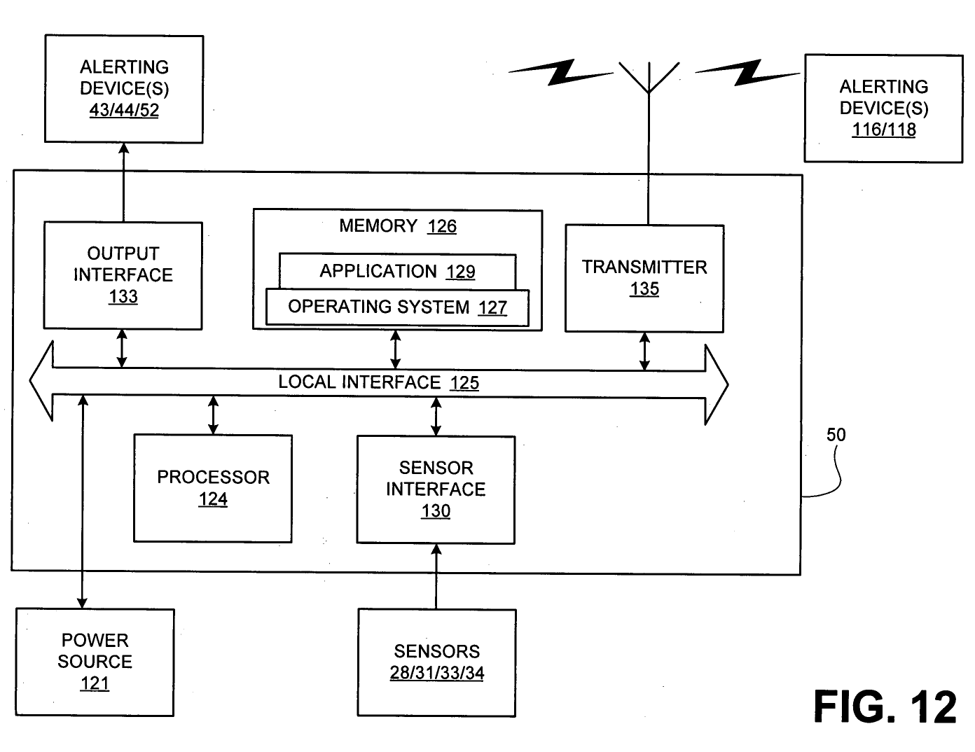

FIG. 12 is a diagram of an exemplary embodiment of the electrical control unit 50 of FIG. 4A and is described in this disclosure. In this nonlimiting example, electrical control unit 50 may be coupled to a power source 121, such as a battery within the tractor 11 of FIG. 3 or a rechargeable battery device.

Electrical control unit 50 includes a processor 124 that executes instructions contained in memory 126. More specifically, memory 126 includes an operating system 127 executable by the processor and one or more application programs 129 for executing instructions and determining whether an object is detected within the rear driving path of tractor trailer 10 of FIG. 3 so that appropriate action can be taken thereafter.

As described above, one or more sensors 28, 31, 33, and 34 (FIG. 3) may be electrically coupled to the electrical control unit 50 via sensor interface 130. Thus, the sensor interface 130 may receive a signal from one or more of the sensors 28, 31, 33, and 34, which is communicated via local interface 135 to processor 124 and/or memory 126. Processor 124 is configured to recognize the signal received as indicating the detected presence of an obstacle or object within the rear driving path of tractor trailer 10 of FIG. 3 when one is detected. Upon such recognition, processor 124 thereafter may be configured to cause one or more alerting devices to activate.

In one nonlimiting example, processor 124 may communicate an output signal to output interface 133, which is electrically coupled to one or more alerting devices, such as visual alerting indicators 43 and 44 of FIG. 3, as well as audio alerting indicator 52 of FIG. 4A. As described in regard to FIGS. 10 and 11, processor 124 may also be configured to communicate an output signal to transmitter 135, which broadcasts an output signal wirelessly to receiver 116. One of ordinary skill in the art would know that a variety of communication methods and protocols could be used to wirelessly communicate the output from processor 124.

One of ordinary skill in the art would also know that electrical control unit 50 may be placed within a housing sufficient for withstanding the environmental conditions for which the electrical control unit may otherwise be subjected to. By positioning the electrical control unit 50 near the sensors 28, 31, 33, and 34, the electrical control unit may be subject to temperature, moisture, and perhaps even road debris during normal operation. So the housing of electrical control unit 50 is configured to withstand these conditions so as to protect the processor and other components described in FIG. 12.

Each of the components described in the object detection system above may be coupled to a vehicle for operation in a variety of mechanisms, as one of ordinary skill in the art would know.

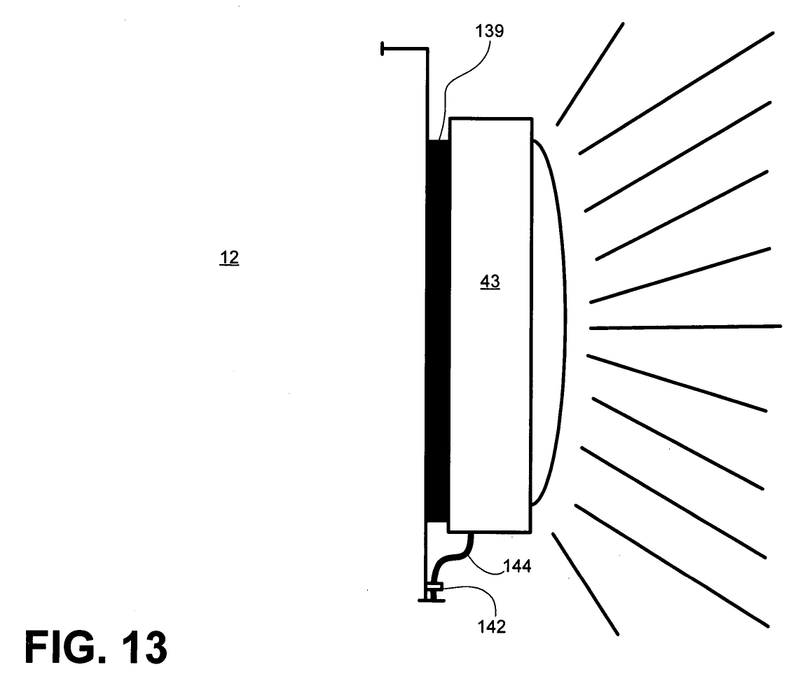

FIG. 13 is a diagram depicting an exemplary embodiment of the visual indicator 43 coupled to the side of trailer 12 of FIG. 3. In this nonlimiting example, visual indicator 43 may be attached to the side wall of trailer 12 via magnet 139 if trailer 12 is of the appropriate metal such that the magnet 139 may attach. However, one of ordinary skill in the art would know that visual indicator 43, as well as each other component described above, may be fastened by screws, bolts, straps, clips, adhesives, ties, etc. as one of ordinary skill in the art would know.

To continue with this nonlimiting example, visual indicator 43 may include electrical connector 144 so as to connect visual indicator 43 with electrical control unit 50, as shown in FIG. 3. One or more cable routing stays 142 may be attached to the side of trailer 12 by the same means described above in regard to visual indicator 43. Thus, as a nonlimiting example, one may install an object detection system as described above by attaching an electrical control unit near the rear portion of the trailer 12 in conjunction with a plurality of sensors 28, 31, 33, and 34. Furthermore, visual indicators 43 and 44 may be magnetically placed or attached by other means upon the side of the trailer 12 with cabling routed and positioned by magnetic stays 142 so that the trailer now becomes equipped with an object detection system that may actually be permitted to remain on the trailer for an extended time. However, the object detection system may likewise be moved quickly and simply to another trailer if so desired. In each instance, though, the driver of the tractor pulling trailer 12 does not need specialized equipment within the cab portion of the tractor for implementing the object detection system, thereby increasing the simplicity of use of the object detection system of this disclosure.

It should be emphasized that the above-described embodiments and nonlimiting examples are merely possible examples of implementations, merely set forth for a clear understanding of the principles disclosed herein. Many variations and modifications may be made to the above-described embodiment(s) and nonlimiting examples without departing substantially from the spirit and principles disclosed herein. All such modifications and variations are intended to be included herein within the scope of this disclosure and protected by the following claims.

1. An object detection system for a vehicle, comprising:
a plurality of positionable sensors detachably coupled to the vehicle and oriented in a direction so as to direct energy into a predetermined area respective to the vehicle;
a control unit electrically coupled to each of the plurality of positionable sensors and detachably coupled to the vehicle proximate to the sensors and configured to receive a signal from one or more of the sensors, the signal corresponding to a detected presence of an object within a predetermined range of the one or more sensors, the control unit electrically coupled to a power source of the vehicle; and
one or more visual alerting devices electrically coupled to the control unit and detachably coupled to the vehicle so that a driver of the vehicle can see the one or more alerting devices through one or more rear view mirrors of the vehicle.

2. The system of claim 1, further comprising:
an audio alerting device electrically coupled to the control unit that is configured to produce an audio alert when the control unit receives a signal from one or more sensors corresponding to a detected presence of an object within the range of the sensor such that the control signal outputs a signal to the audio alerting device to activate the audio alert.

3. The system of claim 1, wherein the plurality of sensors are ultrasonic sensors.

4. The system of claim 1, wherein the control unit is electrically coupled to a circuit that energizes when the vehicle is placed into reverse gear so as to activate the plurality of sensors.

5. The system of claim 4, wherein the control unit keeps the plurality of sensors in an inactive mode when the circuit that energizes when the vehicle is placed in reverse is not energized.

6. The system of claim 1, wherein the plurality of sensors and the one or more visual alerting devices are detectably coupled to the vehicle by a magnet positioned on each sensor and visual alerting device.

7. The system of claim 1, wherein the control unit is positioned proximate to the rear of the vehicle on an underside portion of the vehicle.

8. The system of claim 1, further comprising:
one or more additional visual alerting devices electrically coupled to the control unit and detachably positioned on a rear portion of the vehicle so as to communicate the detection of an object within a detection range of the one or more sensors to an area behind the vehicle.

9. The system of claim 8, wherein an audio alert is produced to warn a person in the rear driving path of the vehicle of the approaching vehicle.

10. A method for detecting the presence of objects within the rear driving path of a vehicle, comprising the steps of:
attaching one or more sensors onto a rear portion of a vehicle so that the sensors direct energy into a predetermined area behind the vehicle;
positioning a control unit module proximate to the one or more sensors so that the control unit may receive a signal from the one or more sensors, the signal corresponding to the detection of an object within the detection range of the one or more sensors; and
activating one or more visual indicators positioned on the side of the vehicle electrically coupled to the control unit so that the driver of the vehicle can visually detect activation of the visual indicators through one or more rear view mirrors of the vehicle.

11. The method of claim 10, wherein the visual indicators are activated by a signal output by the control unit when the control unit receives a signal from the one or more sensors indicating the detected presence of an object within the rear driving path of the vehicle.

12. The method of claim 10, further comprising the steps of:
electrically coupling the control unit to a circuit in the vehicle that energizes when the vehicle is placed into reverse gear so that the one or more sensors are activated when the vehicle is placed in reverse gear.

13. The method of claim 10, further comprising the step of: connecting the control unit to each of the one or more sensors and to the one or more visual indicators.

14. An object detection system for a vehicle, comprising:
a plurality of positionable sensors detachably coupled to the vehicle and oriented in a direction so as to direct energy into a predetermined area respective to the vehicle;
a control unit electrically coupled to each of the plurality of positionable sensors and detachably coupled to the vehicle proximate to the sensors and configured to receive signals from one or more of the sensors, the signal corresponding to a detected presence of an object within a predetermined range of the one or more sensors, the control unit electrically coupled to a power source of the vehicle;
a wireless transmitter coupled to the control unit for wirelessly communicating a signal corresponding to a detected presence of an object within a predetermined range of the one or more sensors; and
one or more alerting indicators having a receiver configured to receive the wirelessly communicated signal, the one or more indicators configured to produce an alert indication upon receipt of the wirelessly communicated signal.

15. The system of claim 14, wherein at least one of the one or more alerting indicators is an illuminating device that is visible to the driver when activated.

16. The system of claim 15, wherein illuminating device is positioned so that a driver of the vehicle can see the one or more illuminating device through a rear view mirror of the vehicle.

17. The system of claim 16, wherein the illuminating device is positioned within a viewable range of the driver in front of the driver on the vehicle.

18. The system of claim 14, wherein at least one of the one or more alerting indicators is a sound producing device that is produces an audio alert when activated.

19. An object detection system for a vehicle, comprising:
a plurality of positionable sensors detachably coupled to the vehicle and oriented in a direction so as to direct energy into a predetermined area respective to the vehicle;
a control unit electrically coupled to each of the plurality of positionable sensors and detachably coupled to the vehicle proximate to the sensors and configured to receive a signal from one or more of the sensors, the signal corresponding to a detected presence of an object within a predetermined range of the one or more sensors, the control unit electrically coupled to a power source of the vehicle; and
an audio alerting device electrically coupled to the control unit that is configured to produce an audio alert when the control unit receives a signal from one or more sensors corresponding to a detected presence of an object within the range of the sensor such that the control signal outputs a signal to the audio alerting device to activate the audio alert.
